(19) United States
(12) Patent Application Publication
(10) Pub. No.: US 2026/0131467 A1
(43) Pub. Date: May 14, 2026

(54) ROBOT POSITION ERROR CORRECTION

(71) Applicant: Intel Corporation, Santa Clara, CA (US)

(72) Inventors: Xuesong Shi, Beijing (CN); Yujie Wang, Beijing (CN); Sangeeta Manepalli, Chandler, AZ (US); Ruchika Singh, Chandler, AZ (US); Rita Chattopadhyay, Chandler, AZ (US); Shay Dekel, Petach Tikva (IL)

(21) Appl. No.: 19/105,746

(22) PCT Filed: Sep. 30, 2022
(86) PCT No.: PCT/CN2022/123657

§ 371 Date: Feb. 21, 2025

(51) Int. Cl. B25J 9/16; B25J 13/08; B25J 19/02

(52) U.S. Cl. CPC B25J 9/1674; B25J 9/161; B25J 13/085; B25J 13/089; B25J 19/023

(57) ABSTRACT

System and techniques for robot position error correction are described herein. A position of a robot may be established based on measurements of an environment of the robot from a first sensor of the robot. An error value based on data from a second sensor of the robot may be obtained. A weight is selected for the error value and a weighted error value is created by combining the weight and the error value. The position and the weighted error value may be combined to create a corrected position that is used as a basis for an operation of the robot.

### TECHNICAL FIELD

Embodiments described herein generally relate to automated control systems and more specifically to robot position error correction.

### BACKGROUND

Robots, such as autonomous vehicles, drones, or industrial tools are mechanical devices that are fully or partially controlled by computers. Using sensors to determine environmental context or physical context (e.g., a joint positioning sensor), a controller provides commands to operate actuators of the robot and perform tasks in the environment.

Autonomous vehicles—such as autonomous automobiles—or industrial robots that move about an environment—such as warehouse robots or automated search and rescue drones—localize themselves within the environment. Example robots may include mobile service robots, last-mile delivery carts, aquatic, terrestrial, or aerial drones, self-driving cars, etc. Generally, for accuracy, planning, or ease of direction, a map is used to guide movement through the environment. Localization of the robot on the map is a task often performed by the robots. Techniques used for localization include Global Navigation Satellite System (GNSS) —for example, a satellite navigation system such as the Global Positioning System (GPS), Galileo, BeiDou Navigation Satellite System (BS), GLONASS, Indian Regional Navigation Satellite System (IRNSS), or Quasi-Zenith Satellite System (QZSS) —Simultaneous Localization and Mapping (SLAM), or Visual Place Recognition (VPR).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of an environment including a system for robot position error correction, according to an embodiment.

FIG. 2 illustrates an example of a self-supervised learning framework, according to an embodiment.

FIG. 3 illustrates an example of a self-supervised learning framework, according to an embodiment.

FIG. 4 illustrates an example of a long-short-term-memory artificial neural network, according to an embodiment.

FIG. 5 illustrates a flow diagram of an example of a method for robot position error correction, according to an embodiment.

FIG. 6 is a block diagram illustrating an example of a machine upon which one or more embodiments may be implemented.

### DETAILED DESCRIPTION

There are difference in outputs and errors, or difficulties related to the type of localization technology used. SLAM, inertial guidance, and other techniques based on direct sensor readings of a near environment often provide frequent updates and smooth data transitions over time but may often introduce compounding errors. As used herein, SLAM includes RADAR SLAM, LIDAR SLAM, Visual SLAM (e.g., optical camera without coordinated emitter although a lamination source such as a spotlight or flash may be used), other similar technologies, including their fusion with an inertial measurement unit (IMU) or wheel odometry data. GNSS, on the other hand, often provides objectively accurate localization on a map, but may suffer from low-resolution (e.g., significant time between readings) or noise. A GNSS sensor typically provides longitude, latitude, or altitude at a low frequency (e.g., one Hertz). The data may be converted to three-dimensional position on a geographic coordinate system, such as the Universal Transverse Mercator Grid System (UTM). Such a measurement may be referred to as a geographic location. For comparison, SLAM typically estimates the robot pose (e.g., position or orientation) at a high frequency (e.g., between ten and thirty Hertz), on a local coordinate system defined by the SLAM system. VPR typically estimates a current pose by calculating a relative transformation between the current camera pose and a previous camera pose that already had a geographic location and whose image is retrieved as the most similar one from a database. The database may also include geotagged image. Combining several localization techniques may provide an ability to overcome the limitations of any given technique to provide more accurate and timely localization results.

Traditional localization techniques that use of multi-modal sensors and Kalman filters are reactive. That is, when a sensor degrades due to a change in the environment—such as an inertial guidance over a bumpy road or in a storm—a period of time elapses before the localization system decreases its reliance on this sensor and starts to rely more on other sensors. For example, if the system had a kind of perfect GPS (e.g., with very small co-variance) signal, the system would likely base the localization almost entirely on the GPS signal because it is accurate and frequent. However, when a tunnel is entered, the co-variance will increase with time, and so the other sensors will become more important for accurate localization after the iterative adjustment provided by the Kalman filtering. During this time period, robot localization is impaired.

To address the issues with current multi-model localization approaches, a proactive adjustment of sensor reliance for localization results is described herein. For example, by accounting for the environment (e.g., environmental context), time of day, weather, etc., the weight for any given sensor may be adapted pro-actively or immediately based on the predicted accuracy variance in the sensor for the context. Accordingly, in the example of the tunnel, immediately upon entering the tunnel the weight for the GPS signal would drop significantly (and not gradually as is the case for a Kalman filter-based adjustment). As a result, more precise localization results are provided in situations where sensor quality changes. If this happens frequently—such as may occur when the robot frequently moves from the indoors to the outdoors and back—the techniques herein may provide better positioning results over traditional techniques, resulting in path planning improvements.

The techniques described herein may be considered a multimodal association followed by a heterogeneous optimization, further made robust, for example, with an artificial neural network (ANN) to adjust the weights on the fly. For example, measurements from different sensors may be connected to form a graph. Then, the measurements may be optimized together to obtain optimal trajectory estimates on an absolute coordinate system (e.g., in the map). Unlike existing approaches, no assumption as to the accessibility of GNSS or SLAM is made other than their common outputs. This eases integration with most public or proprietary SLAM system and GNSS sensors.

Most existing industrial (e.g., factory) robot systems operate indoor only. Localization operates on pre-defined landmarks (e.g., QR codes) or some SLAM algorithm, on a local coordinate system. Self-driving cars on the other hand typically rely on GNSS for rough localization most of the time, and SLAM as a complementary method for GNSS-denied areas. While SLAM may work well for indoor environments and GNSS for outdoor environments, traditional techniques struggle to provide seamless indoor and outdoor transitions. For instance, robots required to operate in last mile delivery or curbside pickup scenarios, encounter GNSS resolution issues while SLAM by itself has difficulty localizing a certain destination, such as a certain car waiting for curbside pickup that may have moved in the parking location.

Because SLAM typically has a higher frame rate that better captures details than GNSS or VPR systems, local variations of an optimized trajectory are typically made as similar to the SLAM trajectory as possible. However, because GNSS or VPR does not suffer from the drift problem of SLAM, the associated poses in the optimized trajectory are typically optimized to be close to the corresponding geographic locations as possible. As noted above, a combination of these techniques, with proactive sensor weight adjustments, are used. Accordingly, a non-linear optimization is used to achieve better performance by re-linearization at the expense of computational cost. For example, considering a cloud-based city-scale high definition (HD) mapping system, accuracy of the constructed map and real time performance are prioritized over applications in resource-constrained platform such as mobile phones where filter-based techniques are frequently used. When compared with optimization-based techniques using a factor map, the present techniques use pose graph optimization as an alternative to construct the optimization graph with a clearer formulation. Additional examples and details are provided below.

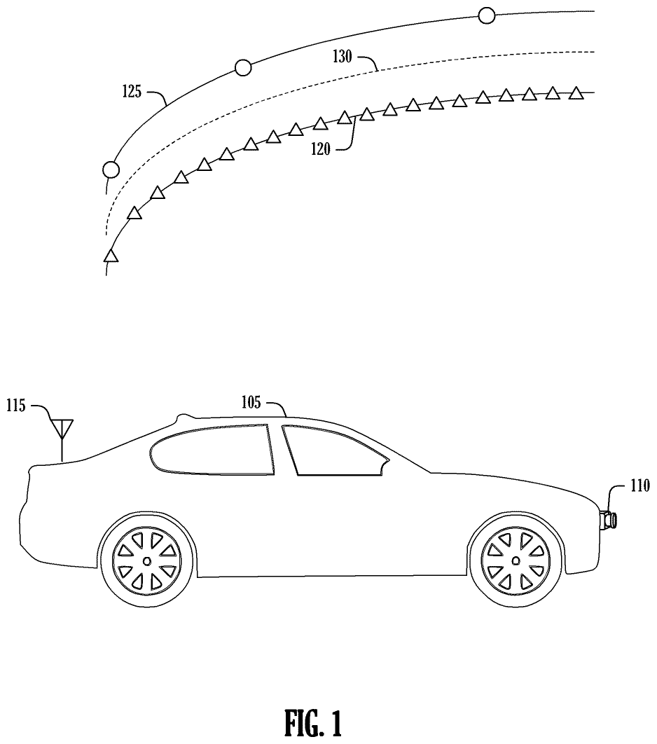

FIG. 1 is an example of an environment including a system 105 for robot position error correction, according to an embodiment. The system 105 is illustrated as an automobile, but any type of robot that uses localization may be used. The system 105 includes a first sensor 110, such as an optical or sonic sensor, and a second sensor 115, such as a GNSS sensor. The system 105 also includes processing circuitry (not illustrated) to perform a variety of tasks that may be static (e.g., the processing circuitry is hardwired) or the processing circuitry may be dynamically configured by software (e.g., programmable) to perform the tasks.

The processing circuitry is configured to establish a position of the system 105 based on measurements of the environment of the system 105 from the first sensor 110. In an example, the first sensor 110 is a sonic sensor. In an example, the sonic sensor is a hypersonic sensor. Such hypersonic sensors are typically used for very close measurements (e.g., within a few feet or less), such as vehicle bumper sensors or warehouse robot bump sensors.

In an example, the first sensor 110 includes an optical sensor. In an example, the optical sensor is a passive sensor. In an example, the passive sensor is at least one of a visual light spectrum camera, an infrared camera, or an ultraviolet camera. Here, the passive sensor captures light, whether visible, infrared, or ultraviolet, without a coordinated emission of that light. Although an emitter, such as a floodlight or a flash, may be used, there is no coordination between the emission and the sensed reflections of that light. Accordingly, these supplemental sources are not needed if there is enough ambient light.

In an example, the optical sensor is an active sensor with an emitter. In an example, the active sensor is at least one of lidar or radar. In contrast to the passive optical sensor, the emission of light in lidar and radar must be coordinated for the result to be used. Thus, not only does excessive ambient presence of light at the lidar frequency still require use of the emitter, the presence of such light may act as noise preventing the lidar measurement from even being made.

The processing circuitry is configured to obtain (e.g., receive, retrieve, or compute) an error value based on data from the second sensor 115. The term error value is used because variance in the result of the position from the second sensor 115 with that from the first sensor 110 represents a possible error in the second sensor 115 or the first sensor 110. In an example, the second sensor 115 is a satellite positioning sensor (e.g., a GNSS). In an example, the second sensor 115 is an inertial sensor, such as an IMU. In an example, the second sensor 115 is a historical record of sensor data. This last example illustrates that the “sensor” may include previously captured data that is presented differently to help indicate or correct errors in the results from the first sensor 110.

The processing circuitry is configured to select a weight for the error value based on a context of the system 105. In an example, the context is obtained from a map of the environment. The map may be an HD map, or other representation, of the environment that is stored in the system 105. In an example, the map includes an indication of second sensor performance at the position. The indication may be a landmark, such as tunnel, to which the system 105 has a correlation indicating sensor performance. In an example, the indication may be a sensor weight adjustment, a percentage decrease in sensor performance, or other indication.

In an example, the weight is selected to reduce correction of the position towards the error value when the indication of the second sensor performance is less than a value. This example covers the situation in which the environmental context negatively impacts the sensor. The value, here, is a threshold or similar metric used to evaluate at what level the second sensor 115 is operating in the context. In an example, when the second sensor is the satellite positioning sensor, the position on the map corresponds to a tunnel that will result in accuracy of the satellite positioning sensor being below a threshold. In an example, when the second sensor is the inertial sensor, the position on the map corresponds to a rough surface that will result in accuracy of the inertial positioning sensor being below a threshold. Other examples may include a featureless expanse, as may occur on large bodies of water, in which SLAM or VPR techniques operate poorly.

The processing circuitry is configured to create a weighted error created by combining the weight and the error value. The processing circuitry is configured to combine the position and the error value are combined to create a corrected position. The illustrated line 120 indicates positioning of the system 105 given the measurements made by the first sensor 110, here assumed to be a high-frequency sampling sensor, such as a SLAM system. The line 125 illustrates a less frequent sampling second sensor 115, such as GNSS. The line 130 indicates the corrected position after combining the position of the first sensor 110 and the weighted error from the second sensor 115. As illustrated, the second sensor 115 weighting is sufficient to move the corrected position of line 130 to be half-way between the first sensor 110 and the second sensor 115. However, when a map indicates that the system is about to transition to a tunnel or other covered environment (e.g., indoors) where a GNSS sensor will suffer, the weighting will reduce the effect of the error values of line 125 and move the position line 130 towards the SLAM line 120.

In multimodal associations, a geographic location from GNSS may be associated with a SLAM pose at given (e.g., nearest) time. Thus, the triangles (e.g., sensor samples of the first sensor 110) of line 120 are associated to the circles (sensor samples of the second sensor 115) of the line 125 based on time. In an example, a VPR transformation may associate a SLAM pose at the query time, to either the pose of a retrieved image or a geotag location for the image. Association between the GNSS data or VPR transformations may be done using time coordinated computing, for example, using the CPU timer as co-related to local Internet Protocol (IP) data that is timestamped and translated to local CPU time. This enables for co-ordination within microseconds real-time window.

For trajectory alignment, a single GNSS measurement or geotag location given by VPR is generally insufficient to provide a geographic coordinate system for SLAM because the measurement or geotag generally do not have orientation (e.g., pose) information. Accordingly, several geographic measurements are generally used to establish a trajectory of the system 105.

With associations between a geographic trajectory (e.g., the line 125 and a SLAM trajectory (e.g., the line 120), an objective may include estimating an optimal geographic trajectory on the geographic coordinate system while maintaining the accuracy of the SLAM trajectory. This may be accomplished by aligning the SLAM trajectory to the geographic trajectory with a rigid transform, resulting in a reasonable initial value for subsequent manipulations. Umeyama's method of least-squares estimation of transformation parameters between two point patterns can be used to calculate the transform. Umeyama's method provides a closed-form solution to minimize the least-squares of distances between aligned positions.

There is a special case: if the two trajectories are nearly linear—such as when a robot moves in a straight line for a while—the relative roll angle between the two trajectories may be unobservable. In this case, prior information (e.g., historical data), for example, that the robot should be standing on the ground (e.g., the x-axis of the camera's optical frame should be parallel to the x-y plane of geographic coordinate system). In an example, this condition is detected after alignment by Umeyama's method, and fixed by rolling the trajectory if the error exceeds a certain threshold. To maintain the alignment of the two trajectories during rolling, the SLAM trajectory is rolled along a line determined by (e.g., between) the initial and final position of the SLAM trajectory. The rolling angle is determined by calculating the angle between the projections onto the normal plane of the rolling angle of the camera x-axis before and after rolling. The initial projection may be calculated as

$${\hat{x}}_{0} = {x}_{0} - ( {x}_{0}^{T} a ) a ,$$

where the vector x₀ denotes the x-axis of the initial camera pose on the aligned SLAM trajectory, and a is the normalized vector from the initial camera position to the final position. The final projection, expected to be pointing rightward—with respect to the expected physical robot frame—of the trajectory, is

$${\hat{x}}_{0}^{′} = a \times z , where z = ( 0 , 0 , 1 )$$

is the unit vector upward—with respect to the world frame—and x for cross production. The rolling angle may then be calculated as

$$ϕ = sign ( {x}_{0}^{T} z ) {cos}^{- 1} ( \frac{{x}_{0}^{T} {x}_{0}^{′}}{‖ {x}_{0} ‖ ‖ {x}_{0}^{′} ‖} ) .$$

The rolling axis a and angle φ together define a three-dimensional Euclidean transformation, which is applied to each pose of the aligned SLAM trajectory.

For multi-modal robot localization, the advantages of different data sources (e.g., sensors) are leveraged to increase accuracy. The optimal combination of the sensor data may be formulated with the following constraints. Because the SLAM system has a higher frame rate that better captures details, the local variations of the optimized trajectory should be as similar to the SLAM trajectory as possible. Because the GNSS or VPR does not suffer from the drift problem (e.g., compounding errors) of the SLAM system, the associated poses in the optimized trajectory should be close to the corresponding geographic locations.

To meet these optimization objectives, the multi-modal robot localization problem may be conceptualized as a non-linear optimization problem by defining three optimization terms. However, more optimization terms may be used when, for example, more sensors (e.g., an IMU) are used. Because GNSS and VPR have similar formulations for optimization, although the following uses GNSS as the example, a similar formulation applies to VPR. To maintain the details of a trajectory, the pose graph constraint that is commonly used in SLAM systems may be used. This constraint encourages the relative pose transformations between adjacent nodes to remain the same after optimization.

$${L}_{pg} = {\sum }_{i , j ∈ ε 1} {e}_{ij}^{- 1} {\sum }_{pg}^{- 1} {e}_{ij} , where {e}_{ij} = {ln ( Δ {T}_{i j}^{- 1} {T}_{i}^{- 1} {T}_{j} )}^{⋁} \qquad ( 1 )$$

Equation (1) results in a visual loss L_{pg}, or the loss associated with SLAM.

Secondly, a GNSS-SLAM constraint (L_{gs}) is used to pull the final trajectory close to the geographic locations. It measures the distance between each geographic location (P_{gps}) with its corresponding SLAM pose in three-dimensional space:

$${L}_{gs} = {\sum }_{i ∈ ε 2} {e}_{i}^{- 1} {\sum }_{gs}^{- 1} {e}_{i} , \qquad ( 2 )$$

$$where {e}_{i} = {T}_{i}^{- 1} {x}_{i} - {P}_{gps} , {x}_{i} = {[ 0 , 0 , 0 ]}^{T}$$

The following optimization constraint uses prior knowledge (e.g., historical sensor data). Consider, for automated robots used in curbside pick-up scenarios, the roads have increases and decreases in elevation, but they are generally flat. Therefore, the constraint encourages the roll angle of the rotation to remain the same after optimization. Note, in the following the subscript to the square brackets—[ ]₃—means to get the third element of the vector.

$$\begin{matrix}{L}_{prior} = {\sum }_{i ∈ ε 1} {e}_{i}^{- 1} {\sum }_{prior}^{- 1} {e}_{i} , where {e}_{i} \\ = {[ {T}_{i}^{- 1} {x}_{i} - {T}_{i}^{- 1} {y}_{i} ]}_{3} , {x}_{i} \\ = {[ 0 , 0 , 0 ]}^{T} , {{y}_{i} [ 1 , 0 , 0 ]}^{T}\end{matrix} \qquad ( 3 )$$

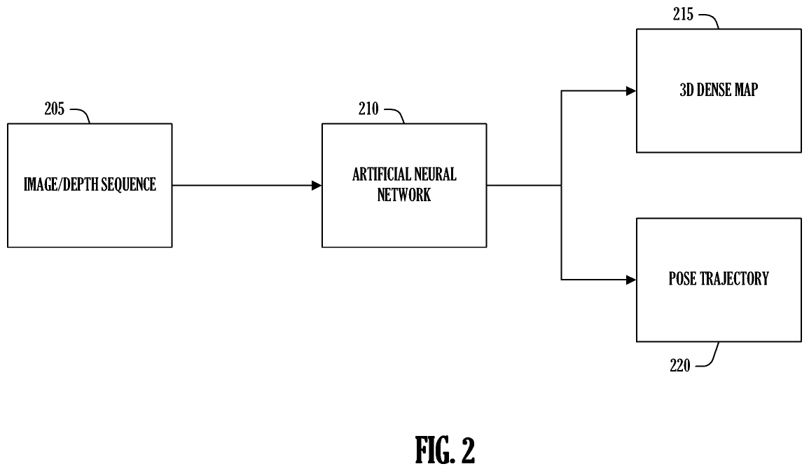

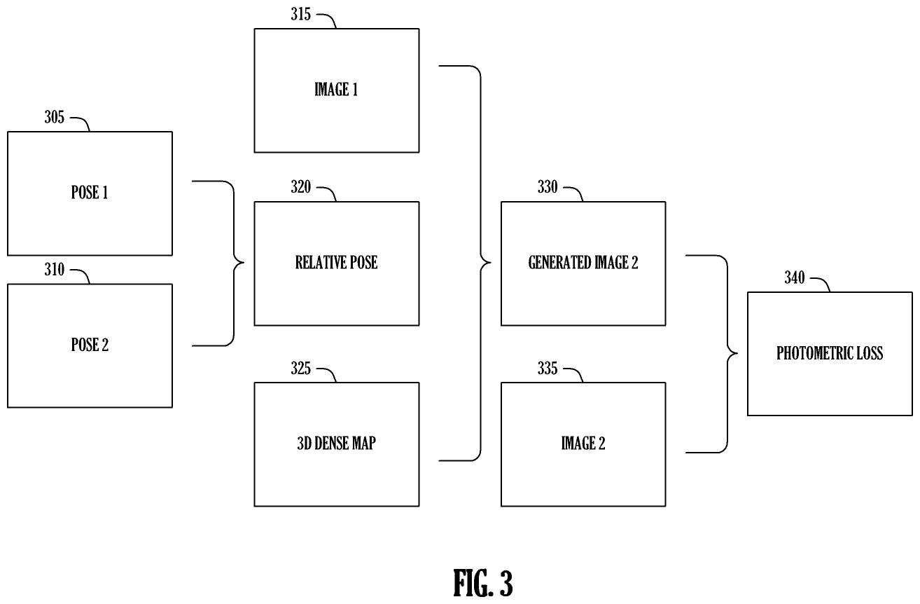

Given these previous constraints—L_{pg}, L_{gs}, and Lₚᵣᵢₒᵣ—the combined loss function may be expressed as the weighted sum of the terms—along with any additional terms such as a constraint for an IMU—as follows:

$${L}_{total} = w 1 * {L}_{pg} + w 2 * {L}_{gs} + w 3 ( fixed ) * {L}_{prior} + w 4 * {L}_{imu} \qquad ( 4 )$$

where w is a weight and Lᵢₘᵤ is a loss for an inertial sensor. FIGS. 2 and 3 provide an example in which an artificial neural network is used to solve the optimization (e.g., minimize the losses).

The processing circuitry is configured to select an operation for the system 105 is selected based on the corrected position. Such operations include a next navigation operation, such as accelerating, turning, etc. The operation may also include non-motive elements, such as sending a signal, operating as an electronic relay, etc. In any case, however, the corrected position is used by the system 105 to make position (including orientation) based actions.

FIG. 2 and FIG. 3 illustrate an example of a self-supervised learning framework, according to an embodiment. The illustrated pipeline may be used to determine the weights from equation (4) above. Learning the weights may be done in an offline mode, for example, by placing the robot in familiar surroundings with ground truth trajectories to collect data over time. For a self-supervised learning approach, photometric loss may be minimized between a synthesized image with an input image in place of the ground truth. Apart from the photometric error, similar errors may be formulated using other sensor inputs, such as lidar, an IMU, etc., for the self-supervised supervision signal.

The artificial neural network model 210 inputs may include an image sequence 205 or a depth sequence. The artificial neural network model 210 may then outputs three-dimensional dense maps 215 or pose trajectories 220. The illustrated pipeline of FIG. 3 uses two frames as an example to illustrate the technique. For the two frames with two timestamps, consider the corresponding image inputs (image1 315, image2 335), and poses (pose1 305, pose2 310). Relative pose 320 between two frames may be generated using the poses of the two frames. Along with image1 315 and a 3D dense map 325, the viewing angle of frame 2 in the context of 3D dense map 325 is known, enabling generation of a new image2 330 by projecting the 3D dense map 325 into the 2D image plane. The generated image2 330 doesn't need to be very precise. For example, it is generally acceptable to have some holes (e.g., unknown pixel values) because the 3D dense map 325 is likely to be imperfect. Instead, only those pixels with known and reliable values are considered when comparing the generated image2 330 with the sensor-captured (e.g., “real”) image2 335 to form photometric loss 340 as the supervision signal. In this manner, the photometric loss may be minimized to achieve self-supervised learning and eliminate the need for ground truth. Again, a similar arrangement may be sued with other sensors, such as lidar, inertial measurements, to create this self-supervision signal.

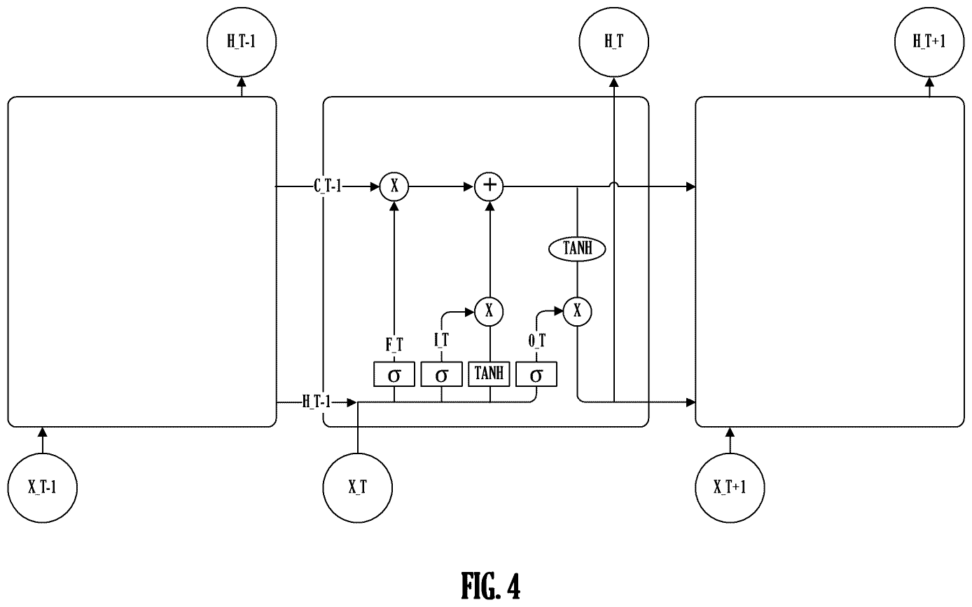

A weight vector is produced after the first and second phases. The weights may be considered fixed at this point. In an example, a forgetting factor may be used to give greater import to current samples and reduce the impact of previous samples over time. After the learning procedure, a trained LSTM deep learning architecture (e.g., as illustrated in FIG. 4) may be used in scenarios where attributes are generated from selected trajectories. These attributes may be used as a sequence input to a deep learning network (DNN). The DNN in may provide adjustments to the weights over time for the objection function, such as equation (4).

Using such model, performance gains over traditional fixed-weight sensor fusion techniques are realized. By dynamically changing the weights, adaption to changes in environmental and sensor conditions is achieved. Further, by incorporating a variety of attributes into the learning framework, extra information that could be helpful for localization is put to use.

FIG. 4 illustrates an example of a long-short-term-memory (LSTM) artificial neural network, according to an embodiment. The following illustrates the use of an LSTM to determine the weights from equation (4). Consider, an initializer to create an initial weights vector [W₁, W₂, . . . , W_{N}] with a uniform distribution, such as

$${W}_{i} = \frac{1}{N}$$

for each i where N=4 in this example. The following is a list of attributes that may be generated from the trajectory and change over time. One or more of these attributes may implicitly affect the resultant weights:
a) L_{pg}, L_{gs}, Lₚᵣᵢₒᵣ and L_{IMU}
b) Light conditions
c) Trajectory curvatures
d) Trajectory diff in x
e) Trajectory diff in y
f) Trajectory diff in z
g) GPS satellite number
h) GPS confidence signal
i) Velocity
j) Acceleration
k) Yaw or Steering angle
l) IMU confidence
m) Floor angle
n) VPR

Given these preliminaries, the processes may include three phases. The first phase does not involve learning, but rather the weights are adjusted according to the known attributes. For example (b) light conditions is correlated to the SLAM performance. Thus, low light conditions generally should decrease W₁ while (g) GPS satellite number and (h) GPS confidence signal are both correlated to the GNSS signal and should impact W₂.

The second phase takes over when the predefined weighting provided in phase one is complete. Here, the LSTM learns the remaining adjustments to the weights over time. Here the input is a vector sequence of a subset of the attributes. These attributes may be considered as “unknown” attributes because the appropriate impact of the attribute on the weights is not previously known. At the end of the second phase, the adjustments to the weights for these unknown attributes may be applied to the weights.

The third phase is not necessary but may provide performance improvements over time. Here, the LSTM re-evaluates all weights to provide further tuning of the weights over time. In an example, the weights are learned in an offline mode by placing the robot in familiar surroundings with ground truth trajectories and collect data over time. In an example, after the weights are learned, a fixed model or policy that has the ability to change the weights on-the-fly given these attributes may be employed. In an example, a forgetting factor may be used to weight learning towards more recent samples and compensate for the current samples.

The loss function for the LSTM may use three additional constraints to delineate the weights. First, the sum of all weights is equal to one (e.g., Σᵢ Wi=1). Second, a smoothness constraint for the trajectory. Such constraints limit maximum variations (e.g., corrections) over a series to create a smooth transition. This, the frequency of weight change may be limited. For example, the weight may be changed every 1,000 frames, but no sooner.

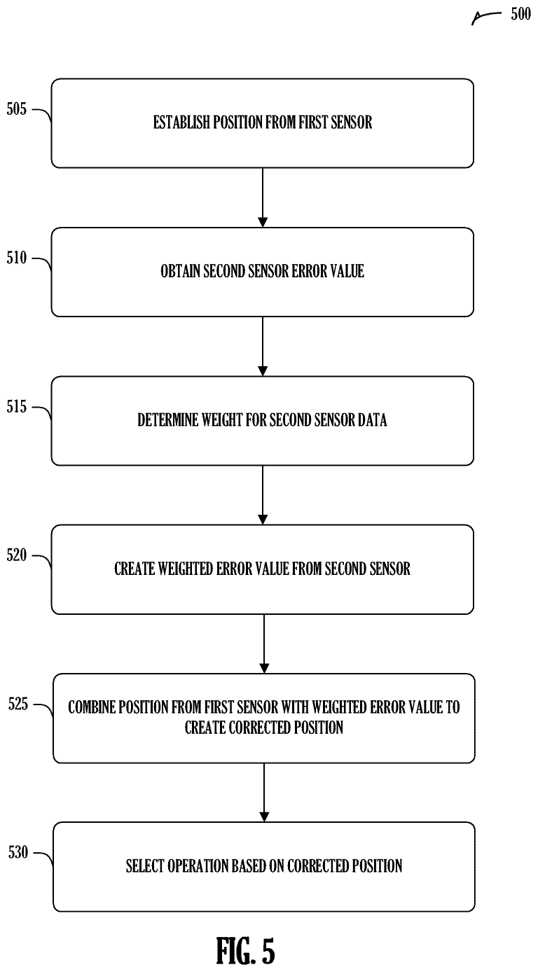

FIG. 5 illustrates a flow diagram of an example of a method 500 for robot position error correction, according to an embodiment. The operations of the method 500 are performed with computer hardware, such as that described above or below (e.g., processing circuitry).

At operation 505, a position of a robot is established based on measurements of an environment of the robot from a first sensor. In an example, the first sensor is a sonic sensor. In an example, the sonic sensor is a hypersonic sensor.

In an example, the first sensor includes an optical sensor. In an example, the optical sensor is a passive sensor. In an example, the passive sensor is at least one of a visual light spectrum camera, an infrared camera, or an ultraviolet camera.

In an example, the optical sensor is an active sensor with an emitter. In an example, the active sensor is at least one of lidar or radar.

At operation 510, an error value is obtained based on data from a second sensor of the robot. In an example, the second sensor is a satellite positioning sensor. In an example, the second sensor is an inertial sensor. In an example, the second sensor is a historical record of sensor data.

At operation 515, a weight for the error value is selected based on a context of the robot. In an example, selecting the weight for the error value based on the context of the robot includes obtaining the context from a map of the environment. In an example, the map includes an indication of second sensor performance at the position.

In an example, the weight is selected to reduce correction of the position towards the error value when the indication of the second sensor performance is less than a value. In an example, when the second sensor is the satellite positioning sensor, the position on the map corresponds to a tunnel that will result in accuracy of the satellite positioning sensor being below a threshold. In an example, when the second sensor is the inertial sensor, the position on the map corresponds to a rough surface that will result in accuracy of the inertial positioning sensor being below a threshold.

At operation 520, a weighted error is created by combining the weight and the error value.

At operation 525, the position and the error value are combined to create a corrected position.

At operation 530, an operation for the robot is selected based on the corrected position.

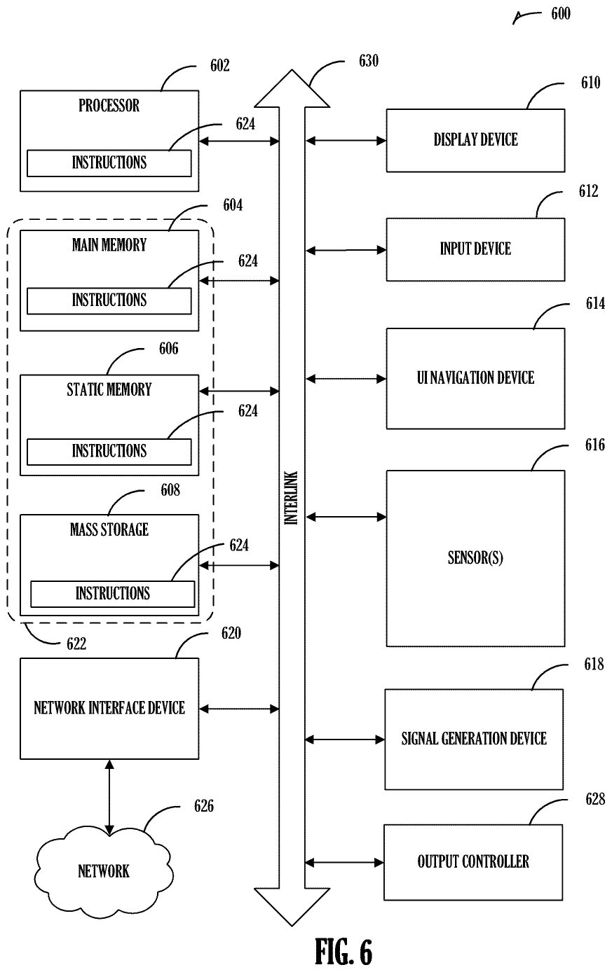

FIG. 6 illustrates a block diagram of an example machine 600 upon which any one or more of the techniques (e.g., methodologies) discussed herein may perform. Examples, as described herein, may include, or may operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 600 follow.

In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 600 may include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), unified extensible firmware interface (UEFI), etc.) 606, and mass storage 608 (e.g., hard drives, tape drives, flash storage, or other block devices) some or all of which may communicate with each other via an interlink (e.g., bus) 630. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 608, a signal generation device 618 (e.g., a speaker), a network interface device 620, and one or more sensors 616, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 may be, or include, a machine readable medium 622 on which is stored one or more sets of data structures or instructions 624 (e.g., software) embodying or utilized by any one or more of the techniques or functions described herein. The instructions 624 may also reside, completely or at least partially, within any of registers of the processor 602, the main memory 604, the static memory 606, or the mass storage 608 during execution thereof by the machine 600. In an example, one or any combination of the hardware processor 602, the main memory 604, the static memory 606, or the mass storage 608 may constitute the machine readable media 622. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 622 may be representative of the instructions 624, such as instructions 624 themselves or a format from which the instructions 624 may be derived. This format from which the instructions 624 may be derived may include source code, encoded instructions (e.g., in compressed or encrypted form), packaged instructions (e.g., split into multiple packages), or the like. The information representative of the instructions 624 in the machine readable medium 622 may be processed by processing circuitry into the instructions to implement any of the operations discussed herein. For example, deriving the instructions 624 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 624.

In an example, the derivation of the instructions 624 may include assembly, compilation, or interpretation of the information (e.g., by the processing circuitry) to create the instructions 624 from some intermediate or preprocessed format provided by the machine readable medium 622. The information, when provided in multiple parts, may be combined, unpacked, and modified to create the instructions 624. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 624 may be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

### Additional Notes & Examples

Example 1 is a device for robot position error correction, the device comprising: an first interface to a first sensor of a robot, the first sensor configured to provide measurements of an environment of the robot; a second interface to a second sensor of the robot; and processing circuitry that, when in operation, is configured to: establish a position of the robot based on measurements, received via the first interface, of the environment of the robot from the first sensor; obtain, via the second interface, an error value based on data from the second sensor of the robot; select a weight for the error value based on a context of the robot; create a weighted error value by combining the weight and the error value; combine the position and the weighted error value to create a corrected position; and select an operation for the robot based on the corrected position.

In Example 2, the subject matter of Example 1, wherein the first sensor includes an optical sensor.

In Example 3, the subject matter of Example 2, wherein the optical sensor is a passive sensor.

In Example 4, the subject matter of Example 3, wherein the passive sensor is at least one of a visual light spectrum camera, an infrared camera, or an ultraviolet camera.

In Example 5, the subject matter of any of Examples 2-4, wherein the optical sensor is an active sensor with an emitter.

In Example 6, the subject matter of Example 5, wherein the active sensor is at least one of lidar or radar.

In Example 7, the subject matter of any of Examples 1-6, wherein the first sensor is a sonic sensor.

In Example 8, the subject matter of Example 7, wherein the sonic sensor is a hypersonic sensor.

In Example 9, the subject matter of any of Examples 1-8, wherein, to select the weight for the error value based on the context of the robot, the processing circuitry is configured obtain the context from a map of the environment.

In Example 10, the subject matter of Example 9, wherein the map includes an indication of second sensor performance at the position.

In Example 11, the subject matter of Example 10, wherein the weight is selected to reduce correction of the position towards the error value when the indication of the second sensor performance is less than a value.

In Example 12, the subject matter of Example 11, wherein the second sensor is a satellite positioning sensor, an inertial sensor, or a historical record of sensor data.

In Example 13, the subject matter of Example 12, wherein the second sensor is the satellite positioning sensor, wherein the position on the map corresponds to a tunnel that will result in accuracy of the satellite positioning sensor being below a threshold.

In Example 14, the subject matter of any of Examples 12-13, wherein the second sensor is the inertial sensor, wherein the position on the map corresponds to a rough surface that will result in accuracy of the inertial positioning sensor being below a threshold.

In Example 15, the subject matter of any of Examples 1-14, wherein the weight is one of multiple weights created by an artificial neural network (ANN) that is trained to receive an image or depth sequence and output a three-dimensional dense map or pose trajectory.

In Example 16, the subject matter of Example 15, wherein in the ANN is trained in an unsupervised manner.

In Example 17, the subject matter of Example 16, wherein the unsupervised manner includes creation, by the ANN, of a predicted image or depth frame, a comparison with a sensor-based image or depth frame that corresponds to the predicted image or depth frame, and correction of the ANN based on differences between predicted image or depth frame and the sensor-based image or depth frame.

In Example 18, the subject matter of any of Examples 15-17, wherein a subset of the multiple weights are fixed.

In Example 19, the subject matter of any of Examples 15-18, wherein a second subset of the multiple weights are variable, being updated by the ANN when the robot is in operation.

In Example 20, the subject matter of Example 19, wherein the subset of the multiple weights and the second subset of the multiple weights overlap with respect to the second sensor, the overlapping weights being additive with respect to the weight.

In Example 21, the subject matter of any of Examples 15-20, wherein the ANN is arranged as a Long-Short-Term-Memory (LSTM) deep learning ANN.

Example 22 is a method for robot position error correction, the method comprising: establishing a position of a robot based on measurements of an environment of the robot from a first sensor of the robot; obtaining an error value based on data from a second sensor of the robot; selecting a weight for the error value based on a context of the robot; creating a weighted error value by combining the weight and the error value; combining the position and the weighted error value to create a corrected position; and selecting an operation for the robot based on the corrected position.

In Example 23, the subject matter of Example 22, wherein the first sensor includes an optical sensor.

In Example 24, the subject matter of Example 23, wherein the optical sensor is a passive sensor.

In Example 25, the subject matter of Example 24, wherein the passive sensor is at least one of a visual light spectrum camera, an infrared camera, or an ultraviolet camera.

In Example 26, the subject matter of any of Examples 23-25, wherein the optical sensor is an active sensor with an emitter.

In Example 27, the subject matter of Example 26, wherein the active sensor is at least one of lidar or radar.

In Example 28, the subject matter of any of Examples 22-27, wherein the first sensor is a sonic sensor.

In Example 29, the subject matter of Example 28, wherein the sonic sensor is a hypersonic sensor.

In Example 30, the subject matter of any of Examples 22-29, wherein selecting the weight for the error value based on the context of the robot includes obtaining the context from a map of the environment.

In Example 31, the subject matter of Example 30, wherein the map includes an indication of second sensor performance at the position.

In Example 32, the subject matter of Example 31, wherein the weight is selected to reduce correction of the position towards the error value when the indication of the second sensor performance is less than a value.

In Example 33, the subject matter of Example 32, wherein the second sensor is a satellite positioning sensor, an inertial sensor, or a historical record of sensor data.

In Example 34, the subject matter of Example 33, wherein the second sensor is the satellite positioning sensor, wherein the position on the map corresponds to a tunnel that will result in accuracy of the satellite positioning sensor being below a threshold.

In Example 35, the subject matter of any of Examples 33-34, wherein the second sensor is the inertial sensor, wherein the position on the map corresponds to a rough surface that will result in accuracy of the inertial positioning sensor being below a threshold.

In Example 36, the subject matter of any of Examples 22-35, wherein the weight is one of multiple weights created by an artificial neural network (ANN) that is trained to receive an image or depth sequence and output a three-dimensional dense map or pose trajectory.

In Example 37, the subject matter of Example 36, wherein in the ANN is trained in an unsupervised manner.

In Example 38, the subject matter of Example 37, wherein the unsupervised manner includes creation, by the ANN, of a predicted image or depth frame, a comparison with a sensor-based image or depth frame that corresponds to the predicted image or depth frame, and correction of the ANN based on differences between predicted image or depth frame and the sensor-based image or depth frame.

In Example 39, the subject matter of any of Examples 36-38, wherein a subset of the multiple weights are fixed.

In Example 40, the subject matter of any of Examples 36-39, wherein a second subset of the multiple weights are variable, being updated by the ANN when the robot is in operation.

In Example 41, the subject matter of Example 40, wherein the subset of the multiple weights and the second subset of the multiple weights overlap with respect to the second sensor, the overlapping weights being additive with respect to the weight.

In Example 42, the subject matter of any of Examples 36-41, wherein the ANN is arranged as a Long-Short-Term-Memory (LSTM) deep learning ANN.

Example 43 is at least one machine readable medium including instructions for robot position error correction, the instructions, when executed by processing circuitry cause the processing circuitry to perform operations comprising: establishing a position of a robot based on measurements of an environment of the robot from a first sensor of the robot; obtaining an error value based on data from a second sensor of the robot; selecting a weight for the error value based on a context of the robot; creating a weighted error value by combining the weight and the error value; combining the position and the weighted error value to create a corrected position; and selecting an operation for the robot based on the corrected position.

In Example 44, the subject matter of Example 43, wherein the first sensor includes an optical sensor.

In Example 45, the subject matter of Example 44, wherein the optical sensor is a passive sensor.

In Example 46, the subject matter of Example 45, wherein the passive sensor is at least one of a visual light spectrum camera, an infrared camera, or an ultraviolet camera.

In Example 47, the subject matter of any of Examples 44-46, wherein the optical sensor is an active sensor with an emitter.

In Example 48, the subject matter of Example 47, wherein the active sensor is at least one of lidar or radar.

In Example 49, the subject matter of any of Examples 43-48, wherein the first sensor is a sonic sensor.

In Example 50, the subject matter of Example 49, wherein the sonic sensor is a hypersonic sensor.

In Example 51, the subject matter of any of Examples 43-50, wherein selecting the weight for the error value based on the context of the robot includes obtaining the context from a map of the environment.

In Example 52, the subject matter of Example 51, wherein the map includes an indication of second sensor performance at the position.

In Example 53, the subject matter of Example 52, wherein the weight is selected to reduce correction of the position towards the error value when the indication of the second sensor performance is less than a value.

In Example 54, the subject matter of Example 53, wherein the second sensor is a satellite positioning sensor, an inertial sensor, or a historical record of sensor data.

In Example 55, the subject matter of Example 54, wherein the second sensor is the satellite positioning sensor, wherein the position on the map corresponds to a tunnel that will result in accuracy of the satellite positioning sensor being below a threshold.

In Example 56, the subject matter of any of Examples 54-55, wherein the second sensor is the inertial sensor, wherein the position on the map corresponds to a rough surface that will result in accuracy of the inertial positioning sensor being below a threshold.

In Example 57, the subject matter of any of Examples 43-56, wherein the weight is one of multiple weights created by an artificial neural network (ANN) that is trained to receive an image or depth sequence and output a three-dimensional dense map or pose trajectory.

In Example 58, the subject matter of Example 57, wherein in the ANN is trained in an unsupervised manner.

In Example 59, the subject matter of Example 58, wherein the unsupervised manner includes creation, by the ANN, of a predicted image or depth frame, a comparison with a sensor-based image or depth frame that corresponds to the predicted image or depth frame, and correction of the ANN based on differences between predicted image or depth frame and the sensor-based image or depth frame.

In Example 60, the subject matter of any of Examples 57-59, wherein a subset of the multiple weights are fixed.

In Example 61, the subject matter of any of Examples 57-60, wherein a second subset of the multiple weights are variable, being updated by the ANN when the robot is in operation.

In Example 62, the subject matter of Example 61, wherein the subset of the multiple weights and the second subset of the multiple weights overlap with respect to the second sensor, the overlapping weights being additive with respect to the weight.

In Example 63, the subject matter of any of Examples 57-62, wherein the ANN is arranged as a Long-Short-Term-Memory (LSTM) deep learning ANN.

Example 64 is a system for robot position error correction, the system comprising: means for establishing a position of a robot based on measurements of an environment of the robot from a first sensor of the robot; means for obtaining an error value based on data from a second sensor of the robot; means for selecting a weight for the error value based on a context of the robot; means for creating a weighted error value by combining the weight and the error value; means for combining the position and the weighted error value to create a corrected position; and means for selecting an operation for the robot based on the corrected position.

In Example 65, the subject matter of Example 64, wherein the first sensor includes an optical sensor.

In Example 66, the subject matter of Example 65, wherein the optical sensor is a passive sensor.

In Example 67, the subject matter of Example 66, wherein the passive sensor is at least one of a visual light spectrum camera, an infrared camera, or an ultraviolet camera.

In Example 68, the subject matter of any of Examples 65-67, wherein the optical sensor is an active sensor with an emitter.

In Example 69, the subject matter of Example 68, wherein the active sensor is at least one of lidar or radar.

In Example 70, the subject matter of any of Examples 64-69, wherein the first sensor is a sonic sensor.

In Example 71, the subject matter of Example 70, wherein the sonic sensor is a hypersonic sensor.

In Example 72, the subject matter of any of Examples 64-71, wherein the means for selecting the weight for the error value based on the context of the robot includes means for obtaining the context from a map of the environment.

In Example 73, the subject matter of Example 72, wherein the map includes an indication of second sensor performance at the position.

In Example 74, the subject matter of Example 73, wherein the weight is selected to reduce correction of the position towards the error value when the indication of the second sensor performance is less than a value.

In Example 75, the subject matter of Example 74, wherein the second sensor is a satellite positioning sensor, an inertial sensor, or a historical record of sensor data.

In Example 76, the subject matter of Example 75, wherein the second sensor is the satellite positioning sensor, wherein the position on the map corresponds to a tunnel that will result in accuracy of the satellite positioning sensor being below a threshold.

In Example 77, the subject matter of any of Examples 75-76, wherein the second sensor is the inertial sensor, wherein the position on the map corresponds to a rough surface that will result in accuracy of the inertial positioning sensor being below a threshold.

In Example 78, the subject matter of any of Examples 64-77, wherein the weight is one of multiple weights created by an artificial neural network (ANN) that is trained to receive an image or depth sequence and output a three-dimensional dense map or pose trajectory.

In Example 79, the subject matter of Example 78, wherein in the ANN is trained in an unsupervised manner.

In Example 80, the subject matter of Example 79, wherein the unsupervised manner includes creation, by the ANN, of a predicted image or depth frame, a comparison with a sensor-based image or depth frame that corresponds to the predicted image or depth frame, and correction of the ANN based on differences between predicted image or depth frame and the sensor-based image or depth frame.

In Example 81, the subject matter of any of Examples 78-80, wherein a subset of the multiple weights are fixed.

In Example 82, the subject matter of any of Examples 78-81, wherein a second subset of the multiple weights are variable, being updated by the ANN when the robot is in operation.

In Example 83, the subject matter of Example 82, wherein the subset of the multiple weights and the second subset of the multiple weights overlap with respect to the second sensor, the overlapping weights being additive with respect to the weight.

In Example 84, the subject matter of any of Examples 78-83, wherein the ANN is arranged as a Long-Short-Term-Memory (LSTM) deep learning ANN.

PNUMExample 85 is at least one machine-readable medium including instructions that, when executed by processing circuitry, cause the processing circuitry to perform operations to implement of any of Examples 1-84.
PNUMExample 86 is an apparatus comprising means to implement of any of Examples 1-84.
PNUMExample 87 is a system to implement of any of Examples 1-84.
PNUMExample 88 is a method to implement of any of Examples 1-84.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1.-25. (canceled)

26. A device for robot position error correction, the device comprising:
a first interface to a first sensor of a robot, the first sensor configured to provide measurements of an environment of the robot;
a second interface to a second sensor of the robot; and
processing circuitry that, when in operation, is configured to:
establish a position of the robot based on measurements, received via the first interface, of the environment of the robot from the first sensor;
obtain, via the second interface, an error value based on data from the second sensor of the robot;
select a weight for the error value based on a context of the robot;
create a weighted error value by combining the weight and the error value;
combine the position and the weighted error value to create a corrected position; and
select an operation for the robot based on the corrected position.

27. The device of claim 26, wherein the first sensor includes an optical sensor.

28. The device of claim 27, wherein the optical sensor is a passive sensor.

29. The device of claim 28, wherein the passive sensor is at least one of a visual light spectrum camera, an infrared camera, or an ultraviolet camera.

30. The device of claim 27, wherein the optical sensor is an active sensor with an emitter.

31. The device of claim 30, wherein the active sensor is at least one of lidar or radar.

32. The device of claim 26, wherein the first sensor is a sonic sensor.

33. The device of claim 32, wherein the sonic sensor is a hypersonic sensor.

34. The device of claim 26, wherein, to select the weight for the error value based on the context of the robot, the processing circuitry is configured obtain the context from a map of the environment.

35. The device of claim 34, wherein the map includes an indication of second sensor performance at the position.

36. The device of claim 35, wherein the weight is selected to reduce correction of the position towards the error value when the indication of the second sensor performance is less than a value.

37. The device of claim 36, wherein the second sensor is a satellite positioning sensor, an inertial sensor, or a historical record of sensor data.

38. The device of claim 37, wherein the second sensor is the satellite positioning sensor, wherein the position on the map corresponds to a tunnel that will result in accuracy of the satellite positioning sensor being below a threshold.

39. The device of claim 37, wherein the second sensor is the inertial sensor, wherein the position on the map corresponds to a rough surface that will result in accuracy of the inertial positioning sensor being below a threshold.

40. At least one non-transitory machine readable medium including instructions for robot position error correction, the instructions, when executed by processing circuitry cause the processing circuitry to perform operations comprising:
establishing a position of a robot based on measurements of an environment of the robot from a first sensor of the robot;
obtaining an error value based on data from a second sensor of the robot;
selecting a weight for the error value based on a context of the robot;
creating a weighted error value by combining the weight and the error value;
combining the position and the weighted error value to create a corrected position; and
selecting an operation for the robot based on the corrected position.

41. The at least one non-transitory machine readable medium of claim 40, wherein the first sensor includes an optical sensor.

42. The at least one non-transitory machine readable medium of claim 41, wherein the optical sensor is a passive sensor.

43. The at least one non-transitory machine readable medium of claim 41, wherein the optical sensor is an active sensor with an emitter.

44. The at least one non-transitory machine readable medium of claim 40, wherein selecting the weight for the error value based on the context of the robot includes obtaining the context from a map of the environment.

45. The at least one non-transitory machine readable medium of claim 44, wherein the map includes an indication of second sensor performance at the position.
